(19) United States
(12) Patent Application Publication
(10) Pub. No.: US 2003/0182177 A1
(43) Pub. Date: Sep. 25, 2003

(54) Collective hierarchical decision making system

(76) Inventors: March S. Gallagher, Saugerties, NY (US); Stephen J. Vitka, Saugerties, NY (US); Andrew H. Bensky, Scotts Valley, CA (US)

Correspondence Address: ROPES & GRAY LLP, ONE INTERNATIONAL PLACE, BOSTON, MA, 02110-2624, US

(21) Appl. No.: 10/397,002

(22) Filed: Mar. 25, 2003

Related U.S. Application Data
(60) Provisional application No. 60/367,172, filed on Mar. 25, 2002.

(51) Int. Cl. G06F 17/60

(52) U.S. Cl. 705/10

(57) ABSTRACT

The systems and methods described herein include systems and methods for proposing and making decisions among alternatives, allocations of resources, or other types of choices, wherein there are multiple decision-makers and each decision-maker may grant one or more proxies to one or more representatives for all, or less than all, of such decision-maker's voting power. Such systems and methods may include allocation of authority to modify decisions under consideration, techniques for participants to propose and seek support for consideration of additional decision alternatives, and for contributing or disseminating information relating to decisions that are pending. The systems and methods described herein facilitate the resolution of any kind of decision capable of definition and resolution using decision trees, including without limitation allocations of value, choices between language alternatives, and binary decisions. These systems and methods may also be used for un-resolving decisions, such as tracking of opinion by category of participant. The system may be used in a number of contexts including direct democracy, legislative process, public relations, customer and employee feedback, corporate governance, portfolio fund investing, collaborative projects, virtual reality governance, intelligent networks, and bidding optimization.

### RELATED APPLICATIONS

This application claims the benefit of U.S. Prov. App. No. 60/367,172, filed on Mar. 25, 2002. The entire contents of that application are incorporated herein by reference.

### FIELD OF THE INVENTION

This invention relates to methods and systems for decision-making, and more particularly to tracking opinion during the decision making process and making collective policy and resource allocation decisions.

### BACKGROUND OF THE INVENTION

Representative systems of governance typically compromise the rights of individuals to participate in decision making processes. Whether applied to government agencies, legislative bodies, corporations, or other institutions and organizations, representative government is predicated upon the election of a small number of representatives who are given plenary power to vote on matters affecting their constituents. In such systems, complex decisions that affect resource allocation, rule making, and other matters, are undertaken by a small number of decision-makers who act on behalf of a larger group. In exchange for freedom from the complexities of decision making, the constituents in these systems accept curtailed rights of participation in the decision-making process.

As a significant disadvantage, voters and shareholders are required to pick a single representative for all decisions, and, conversely, no voter or shareholder is able to divide the assignment of his or her voting power among different representatives each of whom might better represent the shareholder or voter regarding each of the various matters to be submitted to a vote. As another disadvantage, current systems typically require a yes/no vote on an issue Coupled to a majority-determined outcome, while an alternative decision may satisfy a greater number of participants. Furthermore, current representative governance systems do not easily allow for individual constituents to propose alternative decisions or to set parameters by which decisions will be considered.

One reason that traditional collective decision-making processes may not provide optimal solutions is that the method of decision making is generally dictated by external fiat in advance rather than being subject to the decision makers at the time of decision-making. Even if, participants in a process devise its method of resolution, that method is static and cannot be easily modified if it produces results that are less than optimal. The inadequate nature of current decision systems has resulted in voter disenfranchisement, which is evidenced by low voter and shareholder participation rates.

Furthermore, some decision making processes, such as congressional budgeting, consistently fail to align decision-making authority with expertise, knowledge, and popular support. Thus, instead of expenditures going where constituents would like, or where informed experts think that they should, money may be allocated according to non-public agreements among representatives, who exercise control by virtue of rank within their party. As a further disadvantage, this budgeting process may result in resources being unavailable for important programs such as capital maintenance, even when subsequent emergency repairs would be more expensive than maintenance, because participants expend their energy trying to maximize short-term budgetary concessions in their favor.

As a further disadvantage, elected representatives in current systems may “play ball” in order to achieve minor concessions or have their proposals considered. Vote trading and deal making may unofficially form a proxy that accumulates voting power in party leadership rather than forming a proxy that accumulates decision making power where a constituent would like, such as with a suitable expert. For example, the congressional budget process may result in a skewed allocation of public health resources where support does not go to programs that analysis demonstrates to be most efficient for achieving overall goals (such as maximizing lives saved) because power is accumulated in political structures and not in those with the most expertise in a given area. Additionally, a decision maker may sabotage a decision that he would otherwise support, in order to solicit concessions which may not be in accord with the spirit of the main decision, and which may serve entirely unrelated special interests.

Another flaw in current models is that deadlines are static and require decision-makers to make decisions without polling information about how other decision makers have voted. For example, in the 2000 presidential election, voters who chose a third party candidate (Nader) complained that had they known the breakdown of votes between candidates Gore and Bush, they would have changed their votes. If the election process had a floating period beginning when voters cast their votes and ending after they had a chance to change their vote based on the choices of others, a different outcome that may have satisfied an overall greater number of voters may have been achieved.

There remains a need for a participatory form of governance that preserves individual participation while permitting individuals to allocate, by proxy, their participation rights for some or all of the decisions of a governing body to an expert or other representative of the individual's choosing, that allows voting optimization based on review of pending outcomes, and that allow wider participation in the proposal process and determining the manner of decision making.

### SUMMARY OF THE INVENTION

The systems and methods described herein include systems and methods for proposing and making decisions among alternatives, allocations of resources, or other types of choices, wherein there are multiple decision-makers and each decision-maker may grant one or more proxies to one or more representatives for all, or less than all, of such decision-maker's voting power. Such systems and methods may include allocation of authority to modify decisions under consideration, techniques for participants to propose and seek support for consideration of additional decision alternatives, and for contributing or disseminating information relating to decisions that are pending. The systems and methods described herein facilitate the resolution of any kind of decision capable of definition and resolution using decision trees, including without limitation allocations of value, choices between language alternatives, and binary decisions. These systems and methods may also be used for un-resolving decisions, such as by tracking of opinion by category of participant. The system may be used in a number of contexts including direct democracy, legislative process, public relations, customer and employee feedback, corporate governance, portfolio fund investing, collaborative projects, virtual reality governance, intelligent networks, and bidding optimization.

### BRIEF DESCRIPTION OF THE DRAWINGS

The foregoing and other objects and advantages of the invention will be appreciated more fully from the following further description thereof, with reference to the accompanying drawings wherein:

FIG. 1 shows a schematic diagram of the entities involved in an embodiment of a method and system disclosed herein;

FIG. 2 shows a block diagram of a server that may be used with the systems described herein;

FIG. 3 shows a page that may be used as a user interface;

FIG. 4 shows a collaborative decision making process;

FIG. 5 shows a process for determining an architect;

FIG. 6 shows a process for determining a procedural architecture;

FIG. 7 depicts manners in which a participant may proxy authority within a decision making system;

FIG. 8 shows a user interface for interacting with a decision making process;

FIG. 9 shows a user interface for allocating proxy in a decision making process; and

FIG. 10 shows a decision tree going through a proposal process as described herein.

### DETAILED DESCRIPTION OF CERTAIN EMBODIMENTS OF THE INVENTION

To provide an overall understanding of the invention, certain illustrative embodiments will now be described, including a computer-implemented, collaborative, hierarchical decision making system. However, it will be understood that the methods and systems described herein can be suitably adapted to other environments, such as the budgeting, policymaking, and lawmaking applications described herein, as well as any other environment where a problem or opinion situation can be presented as a number of nodes that may be voted on or allocated to by a number of actors. These and other applications of the systems described herein are intended to fall within the scope of the invention. More generally, the principles of the invention are applicable to any environment where resolution of an issue is to be achieved among a number of participants.

Certain terms that are used in the following description are described here for reference. These definitions are not intended to limit the scope of the following description in any way, and should be interpreted, where appropriate, in the broadest sense allowable by law.

The following terms are used to described actors in a system described herein. The term “participant” refers to a user of the decision-making system. The term “author” refers to a participant who can propose nodes. The term “architect” refers to a participant who can create, place, edit, move or delete nodes alone or participate in a collective decision to do so. “Architects” may also determine procedure for such collective decisions. As used herein, the term “reviewer” refers to an architect who controls whether and where sponsored proposal nodes may be upgraded to full decision nodes. An “authority” refers to someone with a high architect status, able to make autonomous decisions, possibly with the ability to override other decisions.

A “representative” is a participant who has received proxy decision making power from one or more other participants. As used herein, the term “proxy” may be used as a verb to describe the delegation of voting authority in the decision tree. A “constituent” refers to a participant who has proxied some or all of her voting rights. A “final proxy” is an irreversible assignment of voting authority to a representative, who may be entitled to reproxy such voting authority. A “full proxy” is a proxy of all sub-decisions below a decision for which the proxy is granted. A “pass through proxy” is a proxy to an “intermediate” who must reproxy the voting authority to a representative. A proxy may be a “secret proxy” in which a constituent remains anonymous.

The following terms are used to describe elements of a decision tree. A “decision tree” is a cluster of nodes from macro nodes to micro nodes. A “root node” is the top level of a tree of one or more nodes. A “sub-node” is a node at a deeper level on a tree, which may be either a branch or a leaf, and “sub-decision” is a decision concerning a “sub-node”. A “branch node” refers to a node that includes one or more nodes beneath/within it. A “leaf node” is a node at the most specific level of detail, that contains no other nodes. The “order” of a node is the level of telescoping depth of a node in the decision tree hierarchy. A “competing node” refers to a node that may eliminate one or more other nodes if accepted by resolution. An “independent node” is a node that does not eliminate other nodes if it is accepted by resolution. As used herein, the term “proposal” refers to a tentative node without sufficient support to be considered a decision node. A “decision” or “decision node” is a sufficiently supported and upgraded proposal node now eligible for votes or value allocation which may be of use in resolution. The term “package” refers to a resolution that is placed as a decision choice in another tree. Terms such as “grow”, “growing”, and “growth” refer to the process by which proposal nodes are added to the tree. The term “archive” refers to records of some or all of past system data sufficient to recreate past states. Terms such as “procedural architecture” or “system parameters” refer to the methods and parameters used within a decision making process.

The following terms are used to describe voting within the decision making process. A vote may be “pending”, during which time votes or allocations may be changed. Terms such as “float” or “floating” refer to a voting period without a deadline or to the period after a deadline during which pending votes may change while awaiting the fulfillment of certain conditions. A “final approval vote” is a yes/no referendum on a node that has already been contingently resolved. The term “final approval” refers to the conclusion of a decision process with a favorable final approval vote.

The following terms are used to describe certain actions within the decision making process or stages thereof. “Sponsorship” is the act of supporting a proposal to be upgraded to a full decision node. A sponsored and upgraded node enters “pre-resolution”, a period lasting until node resolution (if any) begins. The term “resolution” refers to the process of finalizing a node (leaf, branch or tree). The term “selection at percentile” refers to the selection of one member of an ordered set that specifies a percentile of the way from the bottom of the set. A “text node runoff” or simply “runoff” is the process of selection from a set of competing decision nodes.

It should be appreciated that terms such as “vote”, or other terms used to describe a participant's activities with respect to a node are intended to refer to any form of participation in the decision represented by the node, including casting a vote for or against a decision, casting a vote for one among a group of candidates, or assigning a numerical value to a decision such as an allocation of resources, a priority, a statistical value, and so forth. Similarly, the term “decision”, as used herein, may refer to a text-based resolution, a selection of a candidate, or an assignment of value. Thus, phrases such as “voting on a decision” should be understood to refer generally to actions taken by participants with respect to nodes of the system, unless otherwise stated.

Having set forth certain terminology used herein, the description turns to the systems used to implement a collaborative hierarchical decision making system.

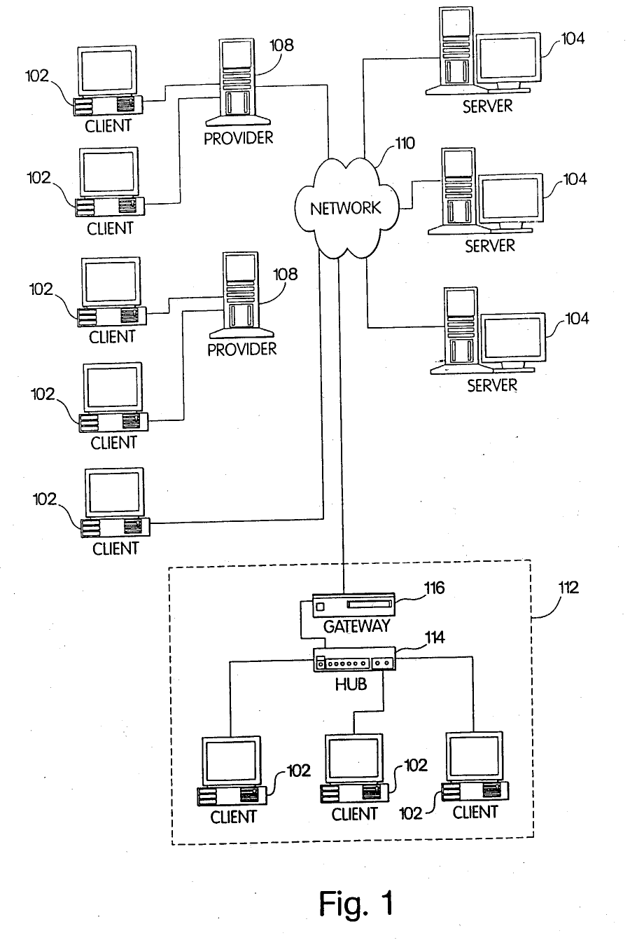

FIG. 1 shows a schematic diagram of the entities involved in an embodiment of a method and system disclosed herein. In a system 100, a plurality of clients 102, servers 104, and providers 108 are connected via an internetwork 110. It should be understood that any number of clients 102, servers 104, and providers 108 could participate in such a system 100. The system may further include one or more local area networks (“LAN”) 112 interconnecting clients 102 through a hub 114 (in, for example, a peer network) or a local area network server 114 (in, for example, a client-server network). The LAN 112 may be connected to the internetwork 110 through a gateway 116, which provides security to the LAN 112 and ensures operating compatibility between the LAN 112 and the internetwork 110. Any data network may be used as the internetwork 110 and the LAN 112.

In one embodiment, the internetwork 110 is the Internet, and the World Wide Web provides a system for interconnecting clients 102 and servers 104 through the Internet 110. The internetwork 110 may include a cable network, a wireless network, and any other networks for interconnecting clients, servers and other devices.

An exemplary client 102 includes the conventional components of a client system, such as a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as modem, digital subscriber line (“DSL”) card, cable modem, network interface card, wireless network card, or other interface device capable of wired, fiber optic, or wireless data communications. One example of such a client 102 is a personal computer equipped with an operating system such as Microsoft Windows 2000, Microsoft Windows NT, Unix, Linux, and Linux variants, along with software support for Internet communication protocols. The personal computer may also include a browser program, such as Microsoft Internet Explorer or Netscape Navigator, to provide a user interface for access to the Internet 110. Although the personal computer is a typical client 102, the client 102 may also be a workstation, mobile computer, Web phone, television set-top box, interactive kiosk, personal digital assistant, or other device capable of communicating over the Internet 110. As used herein, the term “client” is intended to refer to any of the above-described clients 102, as well as proprietary network clients designed specifically for participating in the collaborative hierarchical decision making systems described herein, and the term “browser” is intended to refer to any of the above browser programs or other software or firmware providing a user interface for navigating the Internet 110 and/or communicating with the collaborative hierarchical decision making systems.

An exemplary server 104 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic, and may include separate servers for different functions such as a database server, a file server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. As used herein, the term “server” is intended to refer to any of the above-described servers 104.

Focusing now on the internetwork 110, one embodiment is the Internet. The structure of the Internet 110 is well known to those of ordinary skill in the art and includes a network backbone with networks branching from the backbone. These branches, in turn, have networks branching from them, and so on. The backbone and branches are connected by routers, bridges, switches, and other switching elements that operate to direct data through the internetwork 110. For a more detailed description of the structure and operation of the Internet 110, one may refer to “The Internet Complete Reference,” by Harley Hahn and Rick Stout, published by McGraw-Hill, 1994. However, one may practice the present invention on a wide variety of communication networks. For example, the internetwork 110 can include interactive television networks, telephone networks, wireless data transmission systems, two-way cable systems, customized computer networks, interactive kiosk networks and automatic teller machine networks. Further various data resources may be available through the internetwork 110, including text, images, multi-media, and databases that are provided through command line or graphical front-ends over the internetwork 110, and databases available through local networks connected to the internetwork 110.

One embodiment of the internetwork 110 includes Internet service providers 108 offering dial-in service, such as Microsoft Network, America OnLine, Prodigy and CompuServe. It will be appreciated that the Internet service providers 108 may also include any computer system which can provide Internet access to a client 102. Of course, the Internet service providers 108 are optional, and in some cases, the clients 102 may have direct access to the Internet 110 through a dedicated DSL service, ISDN leased lines, T1 lines, digital satellite service, cable modem service, or any other high-speed connection. Any of these high-speed services may also be offered through one of the Internet service providers 108.

While one embodiment of the internetwork is the Internet, it will be appreciated that other internetworks 110 may be used with the invention. For example, the internetwork 110 may be a wide-area network, a local area network, or corporate area network. The internetwork 110 may be any other network used to communicate data, such as a cable broadcast network.

To further define the resources on the Internet 110, the Uniform Resource Locator system was created. A Uniform Resource Locator (“URL”) is a descriptor that specifically defines a type of Internet resource along with its location. URLs have the following format:

resource-type://domain.address/path-name

where resource-type defines the type of Internet resource. Web documents are identified by the resource type “http” which indicates that the hypertext transfer protocol should be used to access the document. Other common resource types include “ftp” (file transmission protocol), “mailto” (send electronic mail), “file” (local file), and “telnet.” The domain.address defines the domain name address of the computer that the resource is located on. Finally, the path-name defines a directory path within the file system of the server that identifies the resource. As used herein, the term “IP address” is intended to refer to the four-byte Internet Protocol address (or the expanded address proposed for IPv.6), and the term “Web address” is intended to refer to a domain name address, along with any resource identifier and path name appropriate to identify a particular Web resource. The term “address,” when used alone, is intended to refer to either a Web address or an IP address.

In an exemplary embodiment, a browser, executing on one of the clients 102, retrieves a Web document at an address from one of the servers 104 via the internetwork 110, and displays the Web document on a viewing device, e.g., a screen. A user can retrieve and view the Web document by entering, or selecting a link to, a URL in the browser. The browser then sends an http request to the server 104 that has the Web document associated with the URL. The server 104 responds to the http request by sending the requested Web document to the client 102. The Web document is an http object that includes plain text (ASCII) conforming to the HyperText Markup Language (“HTML”). Other markup languages are known and may be used on appropriately enabled browsers and servers, including the Dynamic HyperText Markup Language (“DHTML”), the Extensible Markup Language (“XML”), the Extensible Hypertext Markup Language (“XHML”), and the Standard Generalized Markup Language (“SGML”).

Each Web document usually contains hyperlinks to other Web documents. The browser displays the Web document on the screen for the user and the hyperlinks to other Web documents are emphasized in some fashion such that the user can identify and select each hyperlink. To enhance functionality, a server 104 may execute programs associated with Web documents using programming or scripting languages, such as Perl, C, C++, or Java. A server 104 may also use server-side scripting languages such as ColdFusion from Allaire, Inc., or PHP. These programs and languages perform “back-end” functions such as order processing, database management, and content searching. A Web document may also include references to small client-side applications, or applets, that are transferred from the server 104 to the client 102 along with a Web document and executed locally by the client 102. Java is one popular example of a programming language used for applets. The text within a Web document may further include (non-displayed) scripts that are executable by an appropriately enabled browser, using a scripting language such as JavaScript or Visual Basic Script. Browsers may further be enhanced with a variety of helper applications to interpret various media including still image formats such as JPEG and GIF, document formats such as PS and PDF, motion picture formats such as AVI and MPEG, and sound formats such as MP3 and MIDI. These media formats, along with a growing variety of proprietary media formats, may be used to enrich a user's interactive and audio-visual experience as each Web document is presented through the browser. The term “page” as used herein is intended to refer to the Web document described above, as well as any of the above-described functional or multimedia content associated with the Web document.

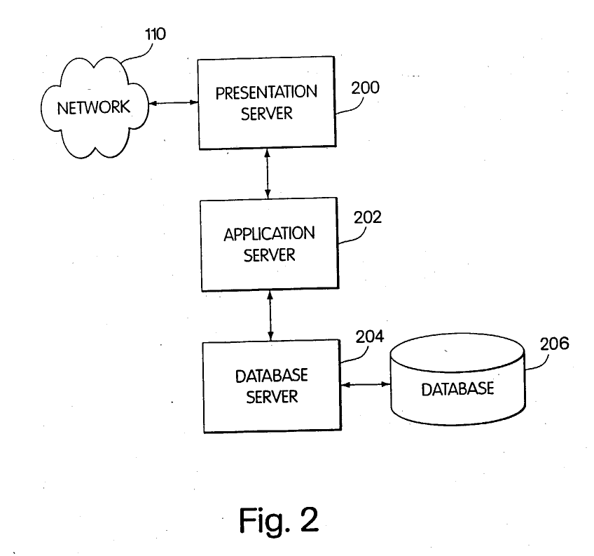

FIG. 2 shows a block diagram of a server that may be used with the systems described herein. In this embodiment, the server 104 includes a presentation server 200, an application server 202, and a database server 204. The application server 202 is connected to the presentation server 200. The database server 204 is also connected to the presentation server 200 and the application server 202, and is further connected to a database 206 embodied on a mass storage device. The presentation server 200 includes a connection to the internetwork 110. It will be appreciated that each of the servers may comprise more than one physical server, as required for capacity and redundancy, and it will be further appreciated that in some embodiments more than one of the above servers may be logical servers residing on the same physical device. It will further be appreciated that one or more of the servers may be at a remote location, and may communicate with the presentation server 200 through a local area or wide area network. The term “host,” as used herein, is intended to refer to any combination of servers described above that include a presentation server 200 for providing access to pages by the clients 102. The term “site,” as used herein, is intended to refer to a collection of pages sharing a common domain name address, or dynamically generated by a common host, or accessible through a common host (i.e., a particular page may be maintained on or generated by a remote server, but nonetheless be within a site).

The presentation server 200 may provide an interface for one or more connections to the internetwork 110, thus permitting more than one of the clients 102 (FIG. 1) to access the site at the same time. In one embodiment, the presentation server 200 comprises a plurality of enterprise servers, such as the ProLiant Cluster available from Compaq Computer Corp., or a cluster of E250's from Sun MicroSystems ruining Solaris 2.7. Other suitable servers are known in the art and are described in Jamsa, Internet Programming, Jamsa Press (1995), the teachings of which are herein incorporated by reference. The server maintains one or more connections to the Internet 110, preferably provided by a tier one provider, i.e., one of the dozen or so national/international Internet backbones with cross-national links of T3 speeds or higher, such as MCI, UUNet, BBN Planet, and Digex. Each server may be, for example, an iPlanet Enterprise Server 4.0 from the Sun/Netscape Alliance. The presentation server 200 may also, for example, use the Microsoft Windows NT operating system, with a “front end” written in Microsoft Active Server Page (“ASP”), or some other programming language or server software capable of integrating ActiveX controls, forms, Visual Basic Scripts, JavaScript, Macromedia Flash Technology multimedia, e-mail, and other functional and multimedia aspects of a page. Typically, the front end includes all text, graphics, and interactive objects within a page, along with templates used for dynamic page creation.

A client 102 (FIG. 1) accessing an address hosted by the presentation server 200 will receive a page from the presentation server 200 containing text, forms, scripts, active objects, hyperlinks, etc., which may be collectively viewed using a browser. Each page may consist of static content, i.e., an HTML text file and associated objects (*.avi, *.jpg, *.gif, etc.) stored on the presentation server, and may include active content including applets, scripts, and objects such as check boxes, drop-down lists, and the like. A page may be dynamically created in response to a particular client 102 request, including appropriate queries to the database server 204 for particular types of data to be included in a responsive page. It will be appreciated that accessing a page is more complex in practice, and includes, for example, a DNS request from the client 102 to a DNS server, receipt of an IP address by the client 102, formation of a TCP connection with a port at the indicated IP address, transmission of a GET command to the presentation server 200, dynamic page generation (if required), transmission of an HTML object, fetching additional objects referenced by the HTML object, and so forth.

The application server 202 provides the “back-end” functionality of the Web site, and includes connections to the presentation server 200 and the database server 204. In one embodiment, the presentation server 200 comprises an enterprise server, such as one available from Compaq Computer Corp., running the Microsoft Windows NT operating system, or a cluster of E250's from Sun MicroSystems running Solaris 2.7. The back-end software may provide back-end functionality including user authentication and authorization, management of decision hierarchy data, and tracking of voting and status for nodes. The software running on the application server 202 may include a software interface to the database server 204, as well as a software interface to the front end provided by the presentation server 200. While the above describes one form of application server that may be used with the systems described herein, it will be appreciated that other configurations are possible.

The database server 204 may be an enterprise server, such as one available from Compaq Computer Corp., running the Microsoft Windows NT operating system or a cluster of E250's from Sun MicroSystems running Solaris 2.7, along with software components for database management. Suitable databases are provided by, for example, Oracle, Sybase, and Informix. The database server 204 may also include one or more databases 206, typically embodied in a mass-storage device. The databases 206 may include, for example, user interfaces, search results, search query structures, lexicons, user information, and the templates used by the presentation server to dynamically generate pages. The databases 206 may also store information about one or more collaborative hierarchical decision making trees, along with voting statistics, descriptive statistics, archived nodes, discussion threads, polling data, authorization data, and any other data. In operation, the database management software running on the database server 204 receives properly formatted requests from the presentation server 200, or the application server 202. In response, the database management software reads data from, or writes data to, the databases 206, and generates responsive messages to the requesting server. The database server 204 may also include a File Transfer Protocol (“FTP”) server for providing downloadable files.

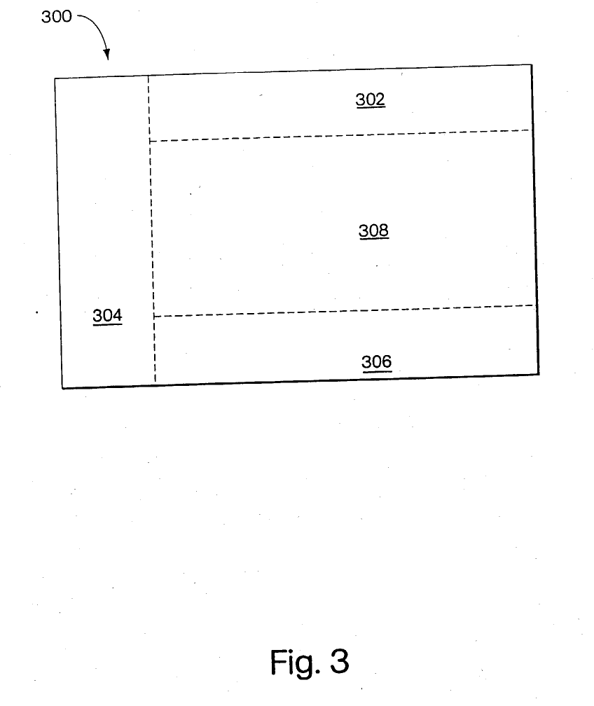

FIG. 3 shows a page that may be used as a user interface. The page 300 may include a header 302, a sidebar 304, a footer 306 and a main section 308, all of which may be displayed at a client 102 using a browser. The header 302 may include, for example, a title of the page. The sidebar 304 may include a menu of choices for a user at the client 102 who is participating in a decision making process through the system. The footer 306 may include information concerning the page such as a “help” or “webmaster” contact, copyright information, disclaimers, a privacy statement, etc. The main section 308 may include content for viewing by the user, such as a hierarchical decision making tree or tools for navigating such a tree. The main section 308 may also include, for example, tools for electronically mailing the page to an electronic mail (“e-mail”) account. It will be appreciated that the description above is generic, and may be varied according to where a client 102 is within a Web site related to the page, as well as according to any available information about the client 102 (such as display size, media capabilities, etc.) or the user (such as proxies to or from the user, architecture authority, voting restrictions, and so forth).

A Web site including the page 300 may use cookies to track users and user information. In particular, a client 102 accessing the site may be accessed to detect whether the client 102 has previously accessed the page or the site. If the client 102 has accessed the site, then some predetermined content may be presented to the client 102. If the client 102 does not include a cookie indicating that the client 102 has visited the site, then the client 102 may be directed to a registration page where information may be gathered to create a user profile. The client 102 may also be presented with a login page, so that a pre-existing user on a new client 102 may nonetheless bypass the registration page.

The site may provide options to the client 102. For example, the site may provide a search tool by which the client 102 may search for content within the site, or content external to the site but accessible through the internetwork 110. The site may include news items topical to the site. The site may provide a user profile update tool by which the client 102 may make alterations to a user profile.

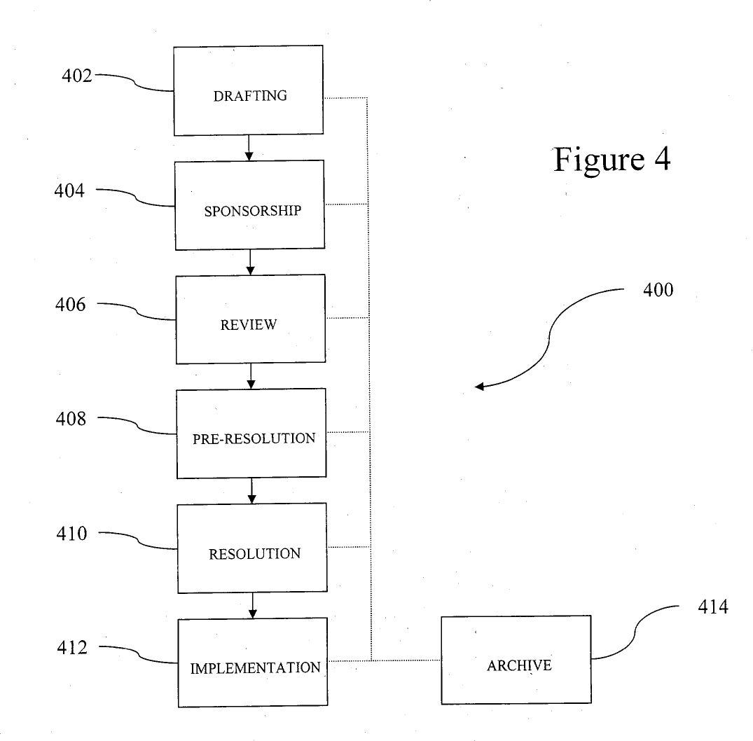

FIG. 4 shows a collaborative hierarchical decision making process. The process 400 may be deployed on any of the systems described above, or any other systems suitable for performing the functions described below, including gathering input from participants and storing information concerning the status of a decision tree or node thereof. Specifics of a decision making process 400 for a node of the system described herein may be affected or determined by other decision making processes within a hierarchical decision making tree or an outside source. Due to such interdependency, or for convenience, it will be understood that the component processes may be ordered, arranged, mixed or combined in various ways.

It will be appreciated that the process 400 may be realized in hardware, software, or some combination of these. The process 400 may be realized in one or more microprocessors, microcontrollers, embedded microcontrollers, programmable digital signal processors or other programmable devices, along with internal and/or external memory for storing program instructions, program data, and program output or other intermediate or final results. It will further be appreciated that the above process 400 may be realized as computer executable code created using a structured programming language such as C, an object oriented programming language such as C++, or any other high-level or low-level programming language that may be compiled or interpreted to run on one of the above clients and or hosts, or combinations thereof.

The components of the process 400 may include drafting 402, sponsorship 404 to become a sponsored proposal node, review 406 of a sponsored proposal node for upgrade to a full decision node, pre-resolution 408 of a node, resolution 410 of a node, and implementation 412 of a node. At any point in this process 400, the node may be archived 414, as indicated by dashed lines to an archive 414. The archive 414 may be viewed as the data set of inactive nodes, such as proposal nodes that were never upgraded, nodes that lose a vote against competing nodes, or nodes that have been resolved. Alternatively, the archive refers to system data, that can be used to reconstruct past system states. The terms “archive” or “archiving” are used interchangeably for these meanings in the following discussions.

Parameter setting steps in the following description indicate the time by which the stated parameters should be set, although they may also be set or pre-designated before that time. Parameter settings could be pre-designated by architects according to the location of the node. For example, all competing nodes may have the same time of resolution. Parameters concerning a node may be described by the author in the node text or might be determined by him or others later. How much decision-making power an authoring architect has over the parameters controlling the proposal process and resolution of his node may be determined by the particulars of his status. Each architect's status may also, or instead be determined in some way by participants.

It should also be noted that during the course of a node's life, the node may be moved to a different branch or tree, or revised. In such circumstances, all sponsorship and pending votes or allocations originally given to the node may revert to the appropriate participants, or may follow the node to its new location within the tree. Tools may be provided within the system to track the revised or moved node, and if participants desire, this new node can be automatically supplied with the support given the old node (unless that is impossible due to, for example, changes in the methodology of sponsorship or voting/allocation which will not translate). These “revision parameters” may be specific to each proposal or to a group of proposals, or may apply to an entire tree.

A node may not proceed through every step described below, and a number of variations are possible. For example, the node may be introduced into the process 400 later than drafting 402 as a result of, for example, another process, a revised node that automatically receives support from another node, a dependent sub-node that is described in another node, or node that is the result of another resolution. As other examples, a node may be automatically sponsored, the pre-resolution stage might be eliminated, or proposals that achieve sufficient sponsorship may automatically become final decisions without a further resolution. Additionally, some nodes may not resolve, but stay pending during some form of implementation without a finalized resolution. These and other variations are intended to fall within the scope of the systems described herein.

Methods of voting and allocation used within the process 400, including those for sponsorship 402, may allow votes or allocation to remain pending until finalization occurs within the resolution 400 stage. A pending vote may be changed until said finalization occurs unless the participant casts a final vote, which may be mandatory in some cases. A period during which a vote may be retracted or changed in such a manner is referred to herein as a “floating period”.

The process 400 may begin with drafting, as shown in step 402. This may include receiving suggestions from participants in the process 400. An architect or author may draft a proposal node, which may be a new node or a revision of a previous node. The architect may consult with reviewers concerning placement of the node, as well as clarity, completeness, internal logic and impact on existing decisions. The author may request and receive from the system an identification number from the system. The author may repeat any of the drafting steps described above to update or replace the proposal node.

Generally, a drafted node may include or be associated with a title, description, a specification of authorized voters and how each may participate, a specification of authority to modify the node, a specification of the node's desired placement within a decision tree (including relationship to any competing, parent, and child nodes), a specification of a notation to identify the placement of the node, and a specification for any process described below as it pertains to the node. However, a drafted node need not contain all of these components, and some may be omitted or supplied later in the process 400. The description, in particular, may include commentary concerning the decision, or may include text (e.g., a candidate name or a language resolution) or a numerical value (e.g. a number, or a variable established by participation, such as an assignment of value, an allocation of priority, an allocation of resources, or any other numerical value). A drafted node may also describe dependent sub-nodes which have associated data analogous to their parent node. Also associated with a drafted node are data and communications useful to participants for voting on or allocating to the node.

The specification of authorized voters may establish who is permitted to vote on the decision and in what manner. This may include all relevant proxy information, or the proxy information may be stored elsewhere and referenced or otherwise employed by a representative when placing one or more votes on the decision. The specification of placement of the node may describe branches to other nodes higher or lower in the hierarchy, if these exist, as well as any competing or otherwise associated nodes. One technique for defining location within the decision tree hierarchy is described in greater detail below. Authority to modify the node may be held exclusively by one participant, or shared among one or more participants that are specifically identified, or who enjoy a specified level of authoring rights within the decision tree. It will be appreciated that all of the attributes described above may be stored in a data structure corresponding to the node such as in a relational database or other storage format suitable for storing nodes in a decision tree.

Once a proposal node has been drafted, the node may proceed to sponsorship, as shown in step 404. At the beginning of the sponsorship stage, the proposal node is placed by an author in a hierarchical decision tree and appropriate signifiers of the node's location within the decision tree are assigned, such as: whether there are parent and/or sub-nodes (which may or may not be root nodes and/or leaf nodes); the relationship to any competing nodes, or alternately that the node is independent. It will be appreciated that placement within a decision tree may be limited by the authors editing privileges. Any parameters, or preconditions to achieving sponsored status may also be established or predetermined at this time and associated with the node in the data structure. This may include a specification of a method of sponsorship and any further requirements for upgrading the node. Review parameters may be set during the sponsorship stage, such as who should be a reviewer for the node, how review of the node will be undertaken, and whether additional layers of review (and appeal) are appropriate. It may also be necessary to determine the effects on other nodes in the decision tree, and to modify other nodes accordingly.

During sponsorship, the node may gain or lose support dynamically, such as through interaction by participants at clients 13 in the above system. This may continue until the occurrence of some event. For example, the requirements for a sponsored status may be met, in which case the node may proceed to review 406. As another example, the resolution of another node that contains the node may cause the node to be archived and the process 400 to terminate for that node. Optionally, sponsorship parameters for the node may be changed and sponsorship may be resumed under the new parameters. As another example, an authoring architect may revise, move, or withdraw the node, in which case sponsorship may revert to participants and the node may be archived.

Once sponsored status is achieved, the process 400 may continue to review, as shown in step 406. During the review stage, one or more reviewers may check the node and reach conclusions concerning the placement, signifiers, clarity, completeness, internal logic, and impact on existing enacted decisions of the node. The proposal may not be upgraded, for example, if all of the lower level nodes connected thereto are not full nodes. Once review has been satisfactorily completed, the sponsored node may be upgraded to a full decision node at its current location in the decision tree. On the other hand, the sponsored proposal node may be rejected, in which case the node may be archived with all sponsorship reverting to participants. In certain cases, a proposal node may not be subject to review, and the node may be upgraded to a full node at its current location once adequate sponsorship has been achieved. It may also be possible for an architect with authority to supercede the reviewers to unilaterally approve the node as a full node.

Once sponsorship and review have been completed, the node may move into pre-resolution, as shown in step 408. At this time, all dependent sub-nodes referenced by the node are also upgraded to full status. Independent proposal sub-nodes may achieve full status as well once they garner sufficient sponsorship and pass review. If the parent node ever loses full status or becomes archived then so do all of its sub-nodes.

Pre-resolution parameters are determined if need be. Any appropriate voting and/or allocation methods may also be set at this time. In some instances, resolution will use a voting method that is a continuation of the method used in pre-resolution. In addition, a date and/or time may be set for the node's resolution, as well as any factors that might change the date and/or time. There may be dependencies for timing. For example, any competing nodes will be resolved at the same time. Optionally, the time of resolution may be unspecified, but may include a contingency such as an event that will establish a time limit for resolution.

In the pre-resolution stage, a full node may gain or lose sponsorship, as well as votes or allocations concerning possible resolution, until established conditions are met. If the node's sponsorship falls below a minimum required for full status, the node may be downgraded and return to sponsorship in step 404. If a specified resolution time is reached (or triggered), then the process 400 may proceed to resolution, as shown in step 410. The time for resolution may, however, be reset, in which case sponsorship and voting/allocation may continue. Other parameters may also be changed or reset, including methods of voting, methods of allocation of value, methods of determining resolution time, and so forth. In certain cases, this may require a return to sponsorship. The node may be archived under certain circumstances, such as when the node is revised, when the node is moved to a different location in the decision tree, or when an authoring architect or a reviewer withdraws the node. At this time, sponsorship and pending votes may revert to participants.

Pre-resolution may be followed by resolution, as shown in step 410. Generally, once a node reaches the resolution stage 410, it may not be withdrawn or revised by its author, because disposition rests at that point with the voting participants; there may be exceptions, however. Additional resolution parameters may be required to be set including, for example, a quorum necessary to resolve the node, description of any floating methods, or setting of any yes/no parameters needed for a decision. The method may also specify when and how final approval vote will be conducted (if any), and when and how a node may be repealed. Repeal parameters may appear in the text of the decision. Parameters may also be established for return to pre-resolution or sponsorship stages. In addition, a method may be prescribed for determining the length of a deliberation period, as well as how the period may be changed. Further, effects on other nodes may be implemented, such as establishing identical resolution parameters for any competing nodes that are to be resolved together.

Once parameters have been established for the resolution stage, a deliberation period may commence. During this period, the node may be downgraded to sponsorship or pre-resolution, or the deliberation period may be extended. At the end of the deliberation period, the voting may be checked for a quorum. If there is no quorum of voters that have voted on the decision, the node may return for further deliberation or be downgraded. If quorum is achieved and the end of the deliberation period is reached, then the vote may be finalized or alternatively, one of the node parameters may specify if the vote is “floating”. If the resolution is floating, then the votes on the node may continue to pend until a second fixed deadline, or indefinitely, or until criteria defined by the method of floating are satisfied, the node is removed or downgraded, or the parameters of the node are changed.

When a node is to be finalized, all pending votes concerning the acceptance of the node are finalized and tallying algorithms are used to calculate final results. Certain methods of floating resolution do not simply use the final votes to calculate results, instead factoring in how the pending vote evolved over the entire floating period. Votes for numerical values within a node may be finalized or continue to pend and be changeable depending on the node's parameters. For example, participants may be able to change an allocation of value in a node although the text of the node has been finalized by resolution. If the vote concerns merely the acceptance of one independent node, then the node may either fail or be approved based on the voting criteria established in that node's method of resolution. If the vote concerns competing nodes, then some nodes may be contingently approved or disapproved based on the resolution criteria. Those nodes that receive this contingent approval may be subjected to another final approval vote, whereby all are finally approved together or independently based on the resolution parameters. This final approval vote may be, for example, a binary vote such as an immediate yes or no. If the node fails for any reason, the node may be archived, or the node may be downgraded to any previous stage for further consideration.

If the node is approved, the node may proceed as a finalized or resolved decision to implementation, as shown in step 412. The manner of implementing the decision node may depend on the characteristics of the node. For example, the decision may be enacted as a policy, rule or law. The decision may be incorporated into another node or decision yet to be resolved, or as a package into another decision tree. Sub-decisions of the decision may be triggered for pre-resolution or resolution, as appropriate, and other nodes may be placed or altered accordingly. In other decision types, architectural positions may be effected, or architects or participants appointed or dismissed, or procedural architecture or parameters changed, and so forth. The decision may continue in force unless repealed, or self-expiring. Whether expired, repealed, or remaining in force, the decision may be archived.

The archive 414 contains a history of nodes and decisions, and may include a record of every prior and current state of decision trees or a history of the entire system, or some selected or filtered set of the history. Archived data may include, for example, node text and signifiers, a history of the node, vote data over time, evolution of trees to which a node was connected, and other relevant data such as communications (e.g., among participants) concerning the node. Other effects of archiving a node may also be stored, such as disposition of new versions of a node that have been introduced to a decision tree, or the manner in which returned votes or sponsorship were cast for related nodes. Thus the archive may store a useful record of growth of one or more decision trees, and nodes thereof, over time, as well as behavior of participants in the collective hierarchical decision making system.

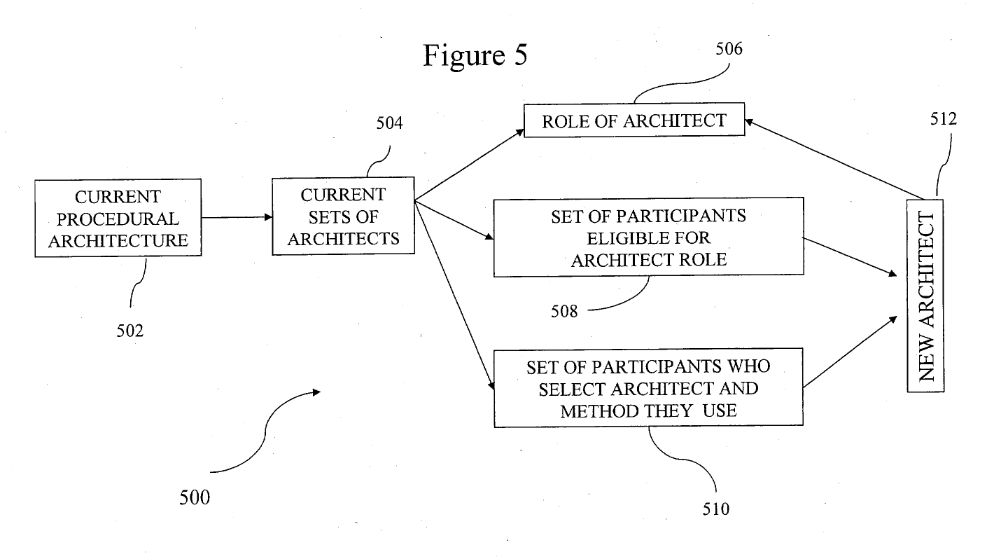

FIG. 5 shows a process for determining architects. It will be appreciated from the above description that architects may play a significant role in advancing a node from drafting to resolution. The process by which architects are selected may be of some importance, particularly in an embodiment where participants choose among architects who have authority to determine aspects of the decision tree architecture. The roles and powers of each architect may be determined by participants, in which case those participants may also be considered architects. In one embodiment, architects may choose various procedural architectures (system parameters) for a decision process, including values for a minimum vote required to make a decision final (quorum), run-off criteria, or the maximum number of proposals that may be sponsored in location. In another embodiment, architects may author and propose nodes, each having proposal powers defined by his role description.

As shown in FIG. 5, the process 500 may begin with a current procedural architecture 502 which establishes current sets of architects that may include all participants or a subset of the participants, as shown in step 504. These current architects 504 may further make decisions according to methods dictated by the current procedural architecture 502. Current architects may have varying powers and participation with regards to these decisions also as described by current procedural architecture 502. These methods and powers may be permanent; or altered, if the current procedural architecture 502 concerning them is altered by another decision process. Once determined by system state 502, one of these current sets of architects then determine roles 506 for certain types of additional architects as limited by system state 502. Different sets of current architects may then determine which participants 508 will be eligible for which architect roles, and which participants and method 510 will be used to select architects from the set 508. These steps may be synthesized into one or more particular architects 512 who will assume the architect roles described.

Generally, the role of an architect 506 may be determined by any suitable decision process. The role may be limited by current procedural architecture 502, which may also provide default limitations on the role of an architect in the absence of explicit decision by the participants. The role description may establish and describe areas in which the architect may submit proposals (author nodes). There may be additional stipulations on an architect with authoring authority over numerous subject matter areas. The architect's authority to determine sponsorship procedures with regard to an authored node may be limited by the specific subject matter area. More generally, a meta-procedure may be defined for determining a procedure from amongst various available procedures at the time of a proposal's submission. The architect may be empowered to choose procedures from predefined options, or a procedural selection might be made by a group of participants. Further procedures or meta-procedures for a node may also be provided or determined, according to each area in which the architect may author nodes by analogous procedure. An architect may also be given additional powers, such as that ability to participate in other procedural architectural decisions, review powers, or powers to affect the powers of other architects or reviewers. Architects may also be explicitly limited in voting on nodes in some areas.

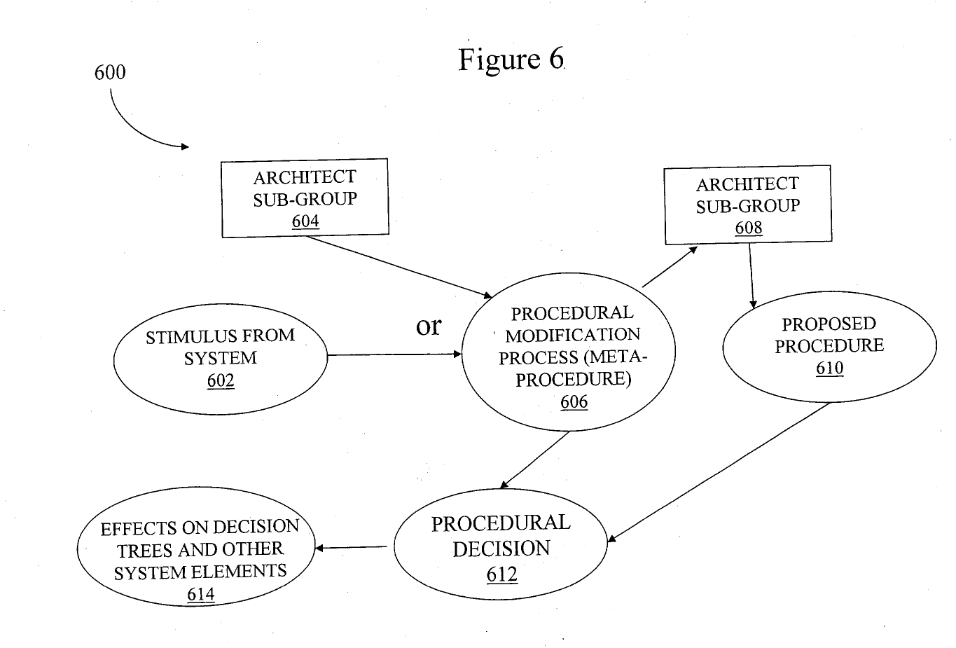

FIG. 6 shows a process for determining a procedural architecture. Procedural rules may be determined in a variety of manners, and may be inflexibly established when the collective hierarchical decision making system is initiated. Or, consistent with the participatory nature of the systems described herein, procedure may be adapted over time according to input from participants and authors. Generally, in an adaptive process that may modify current procedural architecture 600, a system stimulus 602 (e.g., a participant poll or necessity of defining a procedure elsewhere), or a request from an architect or set of architects 604 may initiate a procedural modification process 606. This procedure 606 is specific to the processes to be added, modified or replaced. The method of the meta-procedure 606 is dictated by the current procedural architecture, and may be modifiable by a meta-meta procedure specific to it. In one embodiment, meta-procedures may be used to modify themselves. Continuing, another group of architects 608 described by the meta-procedure 606 may propose procedure 610 for processes described by the specific meta-procedure 606 being used. These may then be resolved to a procedural decision 612 using the meta-procedure 606, which may include procedures described above with reference to FIG. 4. Different architects may participate in this resolution, from those that were empowered to make the procedure proposals. Once resolved, this procedure may be implemented within one or more decision trees as appropriate, and possibly other elements of the overall system are affected as well, as shown in step 614.

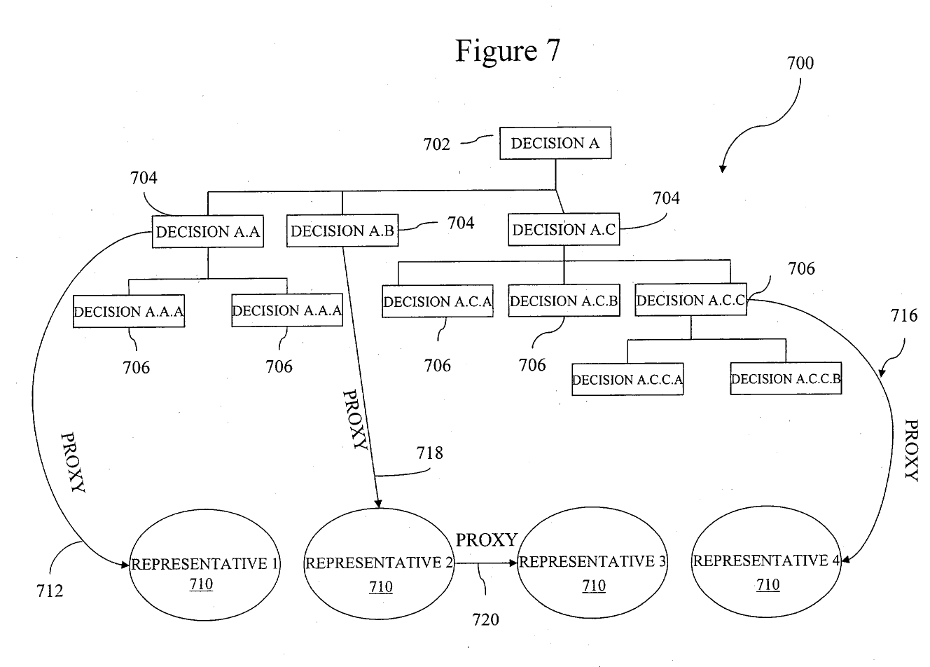

FIG. 7 depicts manners in which a participant may proxy authority within a decision making system. As may be seen in FIG. 7, in the decision tree 700, a zero-order node 702 is depicted as a node having a label “A”. First-order nodes 704 are depicted as nodes having labels “A.x”, where A signifies the zero-order node 702 from which the sub-node depends, and each value of x signifies a different sub-node. Thus the first order nodes 704 are labeled “A.A”, “A.B”, and “A.C”. Second order nodes 706 are depicted as nodes having labels “A.x.y”, where A signifies the zero-order node 702 from which the sub-node depends, x signifies the first-order node 704 from which the sub-node depends, and each value of y signifies a different second-order sub-node. Thus the second order nodes 706 depending from the first-order node, A.C, are labeled “A.C.A”, “A.C.B”, and “A.C.C”. It will be readily appreciated that this labeling or addressing scheme may be used to uniquely identify each node in a decision tree with a name that also identifies a location of the node within the decision tree hierarchy. This addressing scheme could allow identification of a tree with a potentially infinite set of nodes, as after initial use of a single character alphabet, the notation could go on to a double, triple, or quadruple character alphabet using AA, AAA, AAAA and so on, or other symbols or numbers could be used.

A participant may proxy voting authority in a number of manners to a representative 710. For example, a second-order proxy 716 may authorize a representative 710 to act for the participant with respect to a specific second-order node 706, but not with respect to any other nodes, ancestor or descendent. In another form of proxy, a first-order proxy 718 (or any other order of proxy) may be re-proxied 720 by the representative 710 to another representative 710. To illustrate full proxy, consider first-order full proxy 712 may be granted to a representative 710, which authorizes the representative 710 to act for the participant with respect to one of the first-order nodes 704, or any of its descendant nodes in the decision tree hierarchy 700, but not with respect to the zero-order node 702 or other first-order nodes 704 or their descendent nodes. Similarly, a zero-order full proxy (not shown) may authorize a representative 710 to act for the participant with respect to a zero-order node 702, or root node, and any descendent nodes in the decision tree hierarchy 700. It should be appreciated that in the system a participant may control proxy at any level within the hierarchy, and may also limit or prohibit re-proxy. A participant may also require re-proxy in certain instances, and may be permitted to withdraw a tentative proxy prior to finalization of a decision. Generally, the scope and manner of proxy that is permitted may be established as procedural architecture.

In one embodiment, the system procedural architecture may be set to require certain classes of participants to proxy their votes to certain representatives according to circumstances. For example, minors may be required to proxy some decisions to parents. In another embodiment, certain decisions may be automatically proxied to designated representatives unless the participant specifically requests otherwise. In some cases proxying a certain decision may result in other effects on the system such as invoking other mandatory proxies. In other embodiments, the system parameters may allow completely optional proxying. In a tentative proxy, a pending decision made by the proxied representative may return to the constituent for his evaluation. A participant may be able to, depending on system architecture and personal status, approve the decision, modify the decision, or proxy the decision elsewhere. In one embodiment, a participant may volunteer to or be required to assign final proxy to a representative. This final proxy irrevocably assigns the decision making power to the representative, who may still re-proxy elsewhere. The constituent might not be privy to the decision made with his proxied vote.

A flexible proxy system advantageously permits participants to proxy to any other participant authority according to competence, knowledge of the subject matter, or level of interest. Thus experts may garner significant proxy authority on matters within their expertise. Similarly, a participant may proxy authority according to the trusted judgment of a representative (effectively placing the representative in a fiduciary capacity), or a representative 710 may advocate a specific goal or policy, pursuant to which a participant may offer proxy to act according to the stated policy. Thus the voting power of a representative 710 can advantageously increase or decrease according to support within the system for the stated policy of the representative 710. For example, in the legislative budget model, a legislator could proxy his budgetary, decision-making power for public health programs to a legislator who is the head of a relevant committee or a legislator with certain credentials such as a medical degree. Similarly, another legislator could proxy her budgetary decision-making power for defense spending to the Chairman of the Arms Services Committee or to someone who has a military background. Accordingly, certain legislators could accumulate voting power within their area of expertise.

Participants may use a “pass-thru proxy” to proxy their votes to an intermediate participant who cannot exercise the proxied votes themselves, but must re-proxy to a registered representative. This pass-thru option would allow a participant to have someone else choose a participant's representative. Pass-thru proxies may encourage coalition building by allowing blocs of participants to negotiate and communicate with representatives through intermediaries. Representatives may be encouraged to engage in such dialogue by virtue of the significant number of proxies that intermediaries could offer them. In cases of mandatory proxy, such dialog through intermediaries may facilitate greater accountability of representatives to the participants they represent.

The system may allow other participants to discover the representatives to whom a given participant has granted proxy. In other embodiments, a proxy may be kept secret from other constituents, and, optionally, the representative to whom proxy is granted. In such an embodiment, the user may set the system to automatically copy the vote of the selected representative, but no one else is notified of such, including possibly the representative whose vote is being copied. This allows constituents' privacy to insure uninhibited choice. Secret proxy may coincide with constituents' votes being anonymous.

The system may also allow participants to proxy not only “voting” power with respect to an individual node or sub-node, but may further allow a participant to proxy, with the same flexibility, the architectural power such participant may have to (i) make proposals within a node or sub-node, and/or (ii) determine the “procedural architecture” regarding the node or sub-node.

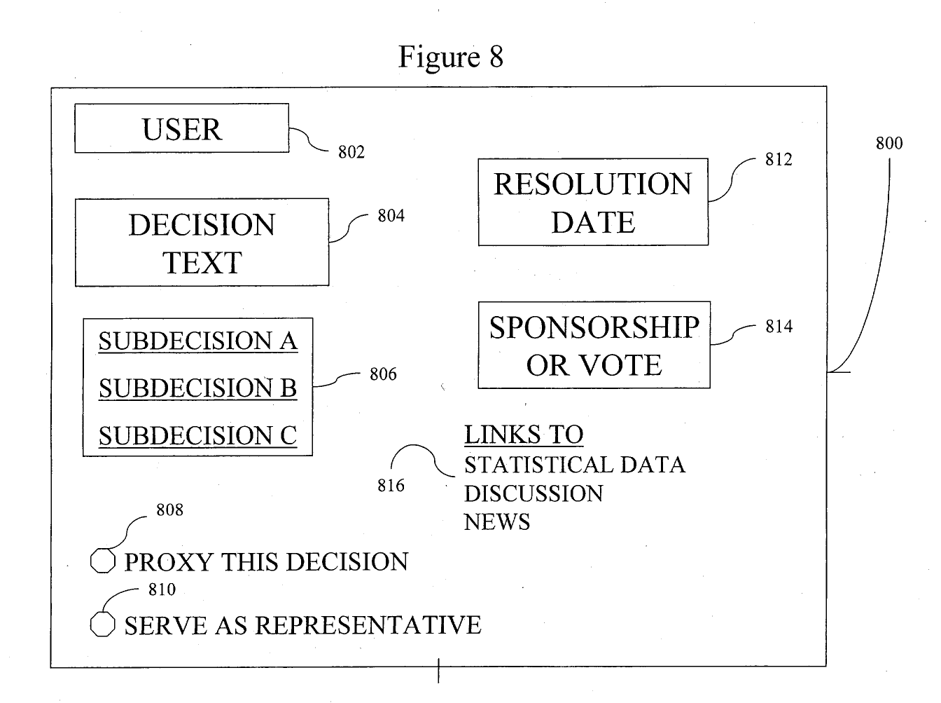

FIG. 8 shows a user interface for interacting with a decision making process. The interface 800 may include, for example, user interface elements described above with reference to FIG. 3, and may more specifically include a user field 802, a decision text field 804, sub-decision fields 806, a proxy control 808, a representative control 810, a resolution date 812, a sponsorship field 814, and links 816 to relevant information. Furthermore, this interface may be customized by the user, so that any of the elements described below may be added, dropped, resized, rearranged or otherwise changed, using, for example, drag and drop “windows”. The interface 800 reflects, by way of example, a node in pre-resolution, and it will be appreciated that other information or controls may be included as appropriate at different chronological points in the life of the node. It should further be appreciated that the controls and fields, and the arrangement thereof, are only by way of example and are not intended to limit the scope of the interface 800 described herein.

The user field 802 identifies a user who is currently logged in on a device and interacting with the system through the interface 800. The decision text 804 may include a title of a node and any other descriptive textual information. The sub-decisions 806 may indicate any sub-nodes within the current node. Although not depicted, ancestor nodes may be displayed by the interface 800 as well, and an entire decision tree, or portions thereof, may be displayed graphically through the interface for inspection and navigation by a user. The proxy control 808 may permit a user to proxy a decision on the node, and may link the user to a page that permits detailed user control over the proxy, as described above. The representative control 810 may permit a user to accept proxy from one or more other participants. The resolution date 812 shows a date on which the node is to be resolved. The “sponsorship or vote” field 814 may permit the user to input sponsorship decisions or votes, including votes in which the user is acting as a representative. The links 816 may include links to any information that might be of interest to a user, such as statistical data concerning the node, other nodes in the decision tree, or concerning the decision under consideration (i.e., polling data, economic data, or other statistical information). The links 816 may also include links to external, commercial news sources, newsgroups, live chat, message groups, bulletin boards, or other resources where a user can interact with other participants or perform research concerning the node. The links 816 may also include statistical information concerning current votes on the node or related nodes, such as median, mean, and range of voting patterns or sponsorship.

It will be appreciated that the user interface 800 may permit interchange among participants in a number of maimers. For example, in a corporate decision making system, the interface 800 could include discussion groups, either through list servers, chat rooms, or message boards, to exchange information and views on corporate operations and related subjects. Or communication could enable live collaboration on drafting and developing strategies or documents. Users could assign, accept, and approve peer proxies, or track pending votes in order to optimize voting strategies. Users could create and participate in surveys or polls. Users could search archives of current and past activities, and research commentary and statistical data, all of which may be available for download in any number of formats.

The interface 800, and other aspects of the systems described herein, may be used in a corporate context for: solicitation and appointment of independent auditors and consultants to investigate and advise on finances, environmental impacts, labor practices or any aspect of operations; determination of accounting practices and standards; determination of regulations and codes of conduct for board, management, and employees; control of disclosure by the company, executives and shareholder; determination of executive and employee compensation packages; nomination and appointment of board members.

The interface 800, and other aspects of the systems described herein, may be used in the legislative context for determining which governmental programs will be funded and what level of funding each program will receive at the line item level. The interface can also be used to make legislative decisions regarding policy such as whether a particular vaccination will be required and if so, at what age.

A wide variety of existing tools may be adopted to let participants communicate, deliberate and facilitate their connection to pertinent information. In this regard, decision nodes may have information separate from, yet associated with, the decision represented by the node, describing purpose, pros and cons, supporters and detractors, and risk-based information, in a manner similar to that provided in current voter information booklets. This information may be enabled by a Usenet or other network-based forum where participants can add remarks and post questions to discussion threads. Search tools and filters would be available to make accessing the information a manageable task suited to that participant's level of interest. Participants may have customizable views of the current status of trees, branches and leaves. Participants may use any number of tools for ease of sorting information such as requesting color-coded comments by origin. Participants may also impose filters so they will only see nodes with a certain level of sponsorship or pending vote support. Additionally, a user may order other participants' comments for his review based on the amount of interest from other participants, in a manner similar to the system used at slashdot.com.

Each representative may have a vote record site where her voting record will be public, at least to the degree required by the system parameters or desired by the participant. Here the representative may present any other information she feels pertinent as well. Thus she may provide context for her voting record through explanation of her stance on issues, broad strategies and alliances, and other information. She can also expound on those to whom she proxies to, or any one else whom she feels worthy of support. She may also criticize opponents' viewpoints. There may be a part of the system outside the editing capabilities of the representative which exists for outside commentary on and public communication to the representative. In this area, anyone may post anything they wish in discussion threads.

All participants may choose to have vote record sites as well and, additionally, each participant may have a system mailbox. Anything sent to a system mailbox may be sent to external email as well if the participant desires it. Incoming mail could be controlled with various filters so that the participant would be able to prioritize it according to source or content. Participants could contact each other based on information each submits to the system, which would give a participant the ability to, for example, contact all the persons who has supported a particular node at one time or another. The system could also be set by a participant to automatically send notification if certain conditions were met, or a prescribed development occurs at a particular node. Integration with instant messaging systems could allow a participant to see which of his contacts were available online for chat purposes. Alternatively, participants may communicate with other participants anonymously using pseudonyms or system ID#s. Representatives could have regular hours of online availability to constituents.

Independent discussion groups concerned with subjects not contained in trees would be supported in this mail system. These discussion groups could help people do such things as create and manage voting blocs, community organize, raise public awareness on certain issues or educate themselves. Communications about tree decisions could segue into collectively creating a larger culture or developing consensus.

The systems described herein may permit, for example, collective authoring of complex optimization strategies in which certain decisions survive over others after being tested, optimized and selected for over time through participant interaction. Representatives will accumulate proxy power based not only on what decisions they support but also on how effective they are at optimizing the vote power that has been assigned to them.

Through the interface 800, the system may give participants the ability to register pending decisions before finally submitting them. This would allow one or more participants to look at a decision tree, make a set of preliminary decisions, see projected outcomes, as if participants' pending decisions were made final, and then finalize them or leave them as pending until a certain date, or until resolution of a node necessitates that they be made final. A participant may set aside some decisions as pending until after he has gathered more information (or perhaps engaged in a predictive analysis), while simultaneously executing some decisions immediately if he is decided.

When a participant enters a pending decision, that participant may specify whether the decision should be executed automatically when the time limit for that decision is reached or, alternatively, that the participant should be prompted immediately before a particular decision is executed so that he has time to change his pending decision if he chooses. In one embodiment, participants may choose to make their pending votes and voting history completely public to influence other voters, or, alternatively, keep their pending vote private until the final vote is tallied. In another embodiment, votes may have their weight influenced by when they are made final and public. Some embodiments may allow pending vote strategy to by automated in accordance with user defined algorithms, so that the user need only set strategy beforehand and then allow the automation to perform appropriate voting. Decision cross-optimization could be automated, whereby voting strategies could be linked so that pending voting or other data in multiple decisions could affect the user's pending vote in any particular decision.

In this regard, trees and each node within them may have associated histories. Participants may view these entire histories, or some portions thereof, through the user interface 800, including the amount of support and from whom, that a node had at accumulated any given time. If a node is eliminated from a tree for any reason, vote or otherwise, it and all of its history and discussions may become part of an archive. The contents of such an archive may be sufficient to recreate the entire system state at any previous point. Thus nodes and the data surrounding them may be accessed by those enabled to if, for example, a issue is reexamined or a participant want to resubmit a failed proposal. For value-based nodes, participants might be able to request information of a mathematical or statistical nature. For example, a participant may want to look at mean and median levels of allocation or graphs depicting past and projected future allocations. Third parties could create plug-ins to the software to provide such tools.

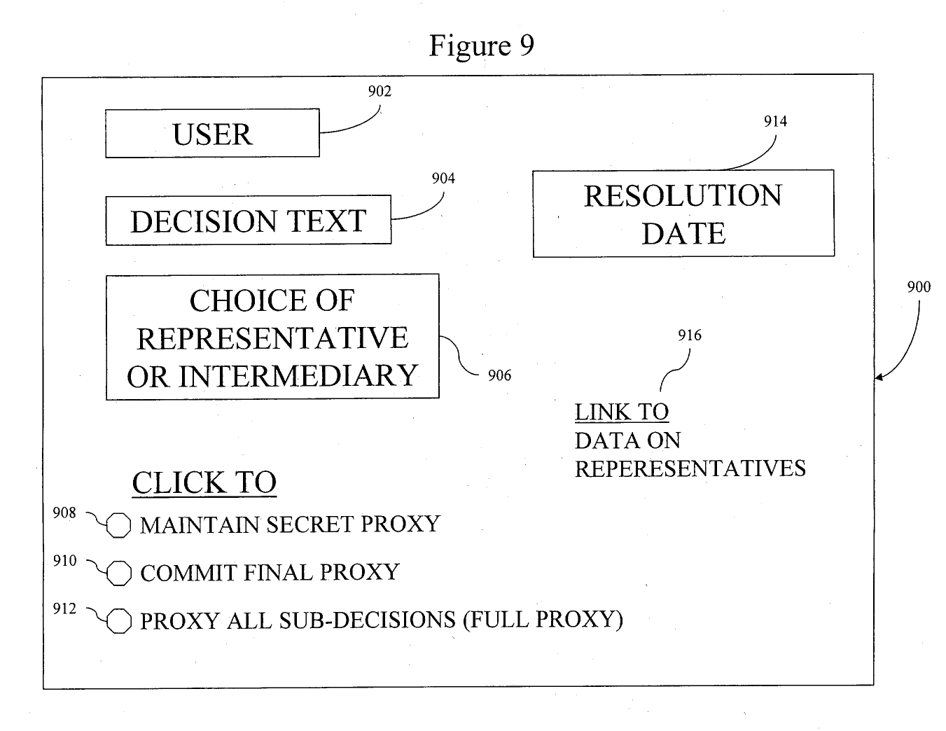

FIG. 9 shows a user interface for allocating proxy in a decision making process. The interface 900 may include, for example, user interface elements described above with reference to FIG. 3, and may more specifically include a user field 902, a decision text field 904, a choice of representative field 906, a secrecy control 908, a commitment control 910, a scope control 912, a resolution date 914, and links 916 to relevant information. Furthermore, this interface may be customizable in manners analogous to those of interface 800. It should further be appreciated that the controls and fields, and the arrangement thereof, are only by way of example and are not intended to limit the scope of the interface 900 described herein.

The user field 902 identifies a user who is currently logged in on a device and interacting with the system through the interface 900. The decision text 904 may include a title of a node and any other descriptive textual information. The representative field 906 may display information concerning a selection of a representative, or permit user input of such information. The secrecy control 908 may permit a user to control a proxy to keep the proxy secret. The commitment control 910 may permit a user to make an irrevocable commitment of proxy for the node. The scope control 912 may, for example, permit a user to simultaneously proxy the authority to act for all sub-decisions. It should be appreciated that each of these controls may have options for greater control, such as providing proxy for a sub-set of all sub-decisions, or maintaining secrecy of a proxy to a specific set of participants. The resolution date 914 shows a date on which the node is to be resolved. The links 916 may include links to data on representatives, such as voting records, policy positions, or areas of expertise of the representative.

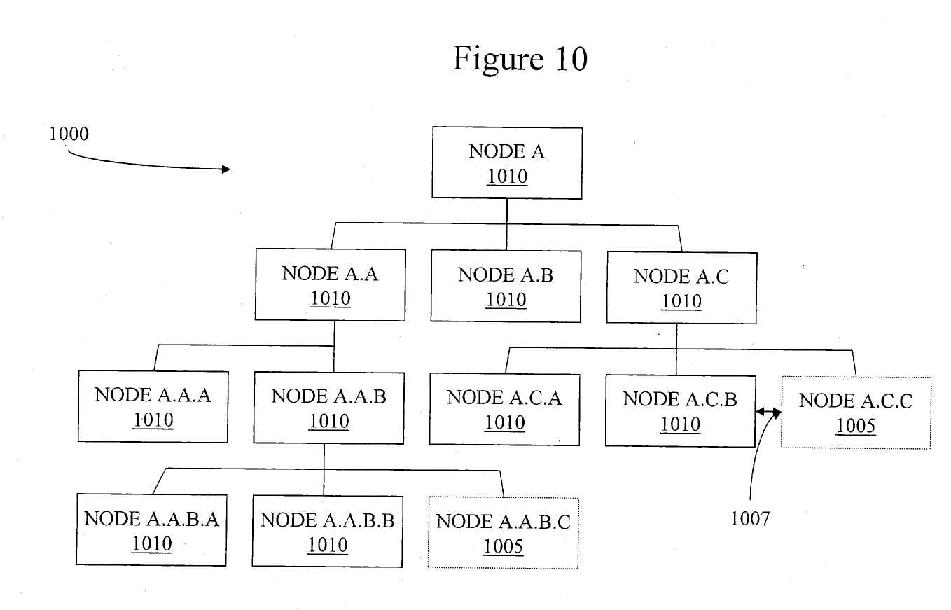

FIG. 10 shows a hierarchical decision tree going through a proposal process as described herein. It will be appreciated that the following description is by way of example only, and is not intended to limit the scope of the systems described herein in any manner. FIG. 10 illustrates how a decision tree 1000 may be formed through the submission of proposals, and the upgrading of proposals to full-status nodes. Proposal nodes 1005, such as node A.C.C and node A.A.B.C are drafted by architects as described above. A proposal may introduce more than one proposal node 1005 if sub-decisions are proposed within the main proposal. If the main proposal is upgraded to a full node 1010, its described dependent sub-decisions are upgraded as well. Sub-decision proposal nodes which are not dependent may be added afterwards, onto an existing proposal. However, such sub-decisions proposals not described within the main proposal, do not automatically upgrade to full nodes when the main proposal does. Additionally, no sub-decision proposal node may upgrade unless contained within a full status decision node.

In one embodiment, authoring architects may attach a limited number of signifiers or key words to nodes to help the participants to proxy to appropriate representatives, a process that may be automated. New proposals may be designated as independent nodes, or as competing nodes that compete with one or more existing nodes, as indicated for example by an arrow 1007 between node A.C.B and node A.C.C. A competing decision is one that if selected will eliminate one or more other nodes. A selected competing node may not necessarily eliminate all other competing nodes when selected. For example, consider a decision process where candidates compete for three positions on a board. Selection of one does not eliminate the other two winners, but does eliminate everyone else, or does reduce the number of available positions. Nodes that receive “value allocation” from a limited pool are generally independent of each other, even though they are competing for the allocation in another sense. Technically, if allocations result in a “zero” allocation to a node, that node is not generally eliminated, so they are not considered to be “competing” with each other.

The procedural architecture of sponsorship may be decided by the same the procedure used for any other decision in the system. There are numerous methods of sponsorship that could be implemented by those skilled in the art. For example, upgrading a proposal node may require a specific percentage of the total participants voting in favor of upgrading the proposal, or it could require participants to rank-order their preferred proposals, with the system incorporating the top-ranked proposals into trees as full nodes, or the system might allocate to each participant a limited pool of sponsorship units, which they could allocate among competing proposals with top-scoring proposal nodes becoming full nodes, after review. In another embodiment, all proposals may become full nodes automatically, subject to approval by reviewers, essentially eliminating the sponsorship step from the process. The procedural architecture for proposing and sponsoring a proposal node may be the same for all nodes within a given tree, or they may vary from node to node. The parameters for sponsorship may be set very liberally to allow many proposals to convert to full nodes or more conservatively to limit the number of choices for which participants must consider voting.

In one embodiment, participants could make comments and access data, and possibly even “pre-vote” on a proposal much like they would for a full status node. A pre-vote would translate to an actual vote if the proposal is upgraded.

Once sponsored, a node may be resolved, as described generally above. Resolution may include allocations of value, choices between language or candidate alternatives (text node runoff), and binary decisions (yes/no). Competing decisions may be eliminated as necessary in a “runoff”. With independent decisions, participants may allocate values or binary decisions to the corresponding independent nodes. “None” or “None of the above” may also be a choice in runoffs.

In allocation of value decisions, participants could allocate probabilities of events, dollars spent, dollars collected, etc. In value allocation decisions, participants could start with a finite amount of value (dollars, or 100% probability) to allocate at the root node, or they may allocate at the lowest leaf nodes and determine the overall root allocation as the cumulative sum of all lower-level allocations. The total amount to be allocated as well as the very categories available for allocation may be selected using the system. For example, in the legislative budget model, a budget may be determined using a fixed value in the root node by taking the prior year's budget and adding or subtracting some percentage, or the budget may be determined by allowing participants to allocate whatever they want to lower level nodes and add it all together to determine the total budget.

The system may use a variety of methods, known to those skilled in the art, to determine a numerical value in a decision node. Such values could be required to set system parameters or to decide an allocation or other value to be included in a piece of text. Values could be determined from the set of all submitted values using an average, low value, high value, selection of a value at a predetermined percentile of the distribution of submitted values (selection at percentile), or by many other methods. A variable numeric value may be fixed when the node that contains is finalized, or it may continue to be influenced by ongoing pending votes.

For other sorts of decisions, participants may use any suitable methods known to those with ordinary skill in the art, or may devise methods for a particular decision. Participants could choose among plurality voting, voting pools, instant runoff, staggered runoff, Borda Count, Approval Voting, Condorcet's Rule, and other analytical methods such as optimization models, linear programming, cost per life saved, risk assessment, and distributional analysis. The methods used may be determined separately for each node, or, alternatively, may be uniform throughout a tree.

A tree may be resolved from leaf towards root. For example, in FIG. 10 assume that nodes a.b.c and c.c are upgraded. In this case, a leaf-to-root resolution would begin with the leaf nodes A.A.A, A.A.B.A,, A.A.B.B, A.A.B.C, A.B, A.C.A, and A.C.C. Alternatively, resolution may proceed from the root toward the leaves, or some combination of these approaches may be used.

Competing nodes may resolve simultaneously as one combined run-off resolution. Independent nodes generally resolve independently at independent times. In some cases, independent nodes may resolve simultaneously, in the same resolution or in linked resolution procedures. Subject to these constraints, participants may choose when a node resolves. For example, a node could have a resolution date and time immediately upon achieving full status, or only once it has accumulated a certain amount of pending votes (pending quorum requirement). The period from the moment a node is upgraded until its resolution is the pre-resolution stage, described in further detail above with reference to FIG. 4. During the pre-resolution stage participants proxy their decision-making power, research decisions, and cast pending votes. As resolution approaches, the date of resolution may be reset by participants if the method of determining time of resolution allows for it. The time of resolution may float as well, determined by an algorithm based on participants changing input.

When resolution begins, there may be a period set aside for deliberation, wherein the given node may be examined closely by participants. Upon the commencement of the resolution of a node, all contained sub-proposal nodes that have not been sufficiently sponsored and upgraded are archived. No further proposals may be placed beneath the resolving node. Resolved and unresolved full decision sub-nodes are fixed. Unresolved sub-nodes may still resolve, but they cannot lose sponsorship and any sponsorship units from a pool or such are returned to that pool as if the sub-node were no longer eligible for sponsorship. (Once a node is finalized however, new proposals may be added to it.) Next, a deliberation period may begin whose length may be set by any of the methods used to set the date/time of resolutions. At the end of the deliberation period, quorum may be checked, to see whether a sufficient number of participants (as determined by the architecture) have voted to make for a valid vote. If quorum fails, then the decision process returns to the pre-resolution stage where new proposals may be upgraded and a new time/method of resolution may be set. Parameters could be set for other conditions to delay resolution as well, such as enough participants voting for delay at any point.

Deliberation period may end in a hard deadline, with pending votes immediately executed after quorum check, with final vote immediately tallied. Alternatively, pending vote allocation readjustment could continue to float after the end of deliberation period until certain conditions were met. This float period could be pre-set in length and use for example a procedure where the winner is determined to be that node which has either maintained supremacy for the most total time, or has had the highest average support over the float period (king of the hill resolutions). Other methods of floating resolution could have pending vote allocation readjustment continue to float until certain conditions were met, such as a winner maintaining supremacy for a set time (open-ended king of the hill resolution), or until the majority, unanimity or anywhere in between accepts the outcome of the vote (attrition or quasi-consensus resolutions). These options create the possibility that a participant may be able to negotiate something in return for accepting a less favorable vote outcome. Once a winner or winners are determined, a “final approval vote” could be required to adopt the final decision. This is particularly of use if “none of the above” was not an option in runoff, or participants lose faith in the process or better options become available after resolution begins. Final approval could be immediate or after another deliberation period. A failed final approval could reject the decision finally, or it could return it to the pre-resolution stage. In one embodiment, a final decision may be subject to being rescinded in the future, for example, if a designated number of qualified participants call for it.

Other features and advantages of embodiments of the systems described herein are set forth below.

The system may be used in a corporate setting, with particular features available to improve corporate governance. Traditionally proxy voting may be supplemented or superceded. Rules such as those governing insider trading, public disclosures of information, or employee or officer codes of conduct may be established using the systems described herein. Similarly, the system may be employed to resolve disciplinary actions for violations of these rules. Users may request disclosure of any aspect of company operations or finances. The system might be employed to determine compensation for executives or board members of a company. Employee salaries may similarly be determined, including bonuses as appropriate. The system may be employed for nomination and election of board members. Shareholder initiatives may be developed and forwarded. Any action of a company may be formally reviewed and certain actions can be subject to referenda beforehand. Shareholders may perform direct allocation of some company resources.

Many alternative methods may be provided within the system to resolve corporate decisions. Users may be permitted to submit new methods, which will expand the capabilities of the system. Each category of decision (determining executive salaries, appointment of board of directors, proposal process etc.) may be preset with an initial preferred method. Users may use a proposal process to choose amongst native decision methods or to customize/author their own. The proposal process may impact itself, changing its own method. New categories of decisions may be proposed and approved along with their attendant methods. Different proposal processes may be used dependent on the subject of a proposal as well. Decision methods can be very complex including details such as provisions for sub-decisions being made first or after, basic winner algorithms being combined, conditions for sponsorship required to become available to a final vote and resolution, quorum, and flexible or floating vote deadlines. Shareholders may appoint a classification committee to decide what category a decision falls under, and hence what method will be used for its resolution.

While shareholders and corporate officers will hold special decision making powers, other users will be able to participate as well. Opinion is collected from all users, so that while a user may not directly participate in a decision, he may always participate in the dialog and the creation of collective opinion. This is important, for example, in tracking the level of satisfaction with implemented decisions. The system may compile votes and associate them with participants or groups of participants. This association may be anonymous or public, depending upon the application. Associations may be formal, with members corresponding to membership in external groups: stockholders, members of a pension fund, the AARC, a political party, or union; or informal, with members self-identified: ad hoc groups to support a certain agenda, associations by interests, lifestyle, profession, geography etc.

As a more specific example of an application to corporate governance, the system may be employed for the solicitation and appointment of independent auditors. Users may develop proposals for the type of auditing or consulting required. Once details are finalized, these may be posted in a solicitation of services area on a company web site. Candidates for the position/contract described may post resumes, qualifications, proposed solutions and fees. Users may negotiate with candidates and then select one or more candidates to fulfill the mandate of the auditing/consulting proposal. Such consultants/auditors may be given various powers of investigation and consultation, pursuant to the system, that they may not have obtained otherwise. Generally, auditors simply use the company's financial data, and audit it for consistency and believability without having the ability to verify it. If auditors/consultants are exposed to information that could hurt the company if made public, for example, trade secret intellectual property, exposure to substantial liabilities, or problems that might be remedied discreetly, they may be empowered not to reveal such information to the shareholders (and hence the public) at the shareholders' request.

The system is also capable of providing many alternatives for resolving legislative decisions, and may be employed by elected officials in a representative legislative body, or by individual voters in a structured referendum process. Any decision undertaken by a legislative body can be decided using the collective hierarchical decision system. For example, participants could allocate resources to governmental programs, set environmental standards, apportion tax burdens, choose penalties for drunk driving, and so on. Users may use a proposal process to choose amongst traditional legislative majority rules decision methods or other democratic implementations. Users can propose entire new categories of programs or laws and approve them along with specific methods of resolution. Democratic representation no longer needs to be limited to mere geographic representation, but can be take on a multitude of facets in which participants choose a myriad of representatives that align most with their position in specific areas. Coalitions of participants in legislative models can be built and will naturally form around certain policy issues and representatives.

The system could be implemented in a government body where certain representatives may be officially sanctioned. For example, the budget model could be implemented in Congress with all members proxying their budgeting decisions to those members on the House Budget and Senate Finance Committees, but opinion would be collected from all members. The flexibility of the system makes it easily grafted on to current government systems. The system could also be implemented at any other level of government including town, counties, states or provinces, wherein officials elected under current systems use the system inside of already existing structures. Or more radically, the system could replace current election based on geography methods.

The system may also be employed in a computer gaming environment. For example, in a virtual reality governance model, participants in virtual worlds, such as SimCity, or ad hoc multi-user dimensions (also known as MUD's) can chose representatives who most closely mirror their position in any facet of “virtual life.” Furthermore, participants can decide the physical laws or other properties of their virtual universe, such as by using the system to assign probabilities to the occurrence certain events.

A legislative body can apply the system to create budgetary allocations. One straight forward approach would be to examine total amount of a prior year's budget or an executive budget, make some percentage adjustment. Divide the total by the number of legislators and give each legislator an equal share of the total. Legislators would then use the system to set deadlines, determine parameters of the process, and propose new spending categories.

Each legislator would then enter their pending votes, allocating part of the overall budget to any category either directly or indirectly through proxy. Pending votes would be incorporated into up to the minute information about totals for each category. Threshold levels of legislative support could be required to add new spending categories or continue funding an item. Funds could be returned to each legislator for any item without sufficient multi-lateral support for reallocation by a certain deadline. At some predetermined deadline, the votes would finalize and the decision would be finished. Different categories of spending could have unique floating periods and finalization deadlines. Any item not receiving any funding could be removed from the budget

To illustrate this process, it is instructive to simultaneously develop an example of application in the Federal Budget process. The federal budget it made up of sixteen general spending categories. These general spending categories provide the first-order decision nodes. Each spending category is a first-order decision node to which would be assigned the following addresses.

| Federal Budget Spending Categories | Address |
|---|---|
| National defense | Nodeₐ |
| International affairs | Node_{b} |
| General science, space, and technology | Node_{c} |
| Energy, Natural Resources and Environment | Node_{d} |
| Agriculture | Nodeₑ |
| Commerce and housing credit | Node_{f} |
| Transportation | Node_{g} |
| Community and regional development | Nodeₕ |
| Education, training, employment, and social services | Nodeᵢ |
| Health | Nodeⱼ |
| Medicare | Nodeₖ |
| Income security | Nodeₗ |
| Social security | Nodeₘ |
| Veterans benefits and services | Nodeₙ |
| Administration of justice | Nodeₒ |
| General government | Nodeₚ |

Furthermore, as each of these spending categories is made up of spending sub-categories, they are all considered branch nodes. We will use the category General Science, Space and Technology as an example. General science, space and technology category may be referred to as a first-order decision node with the address Node_{c}. The General Science, Space and Technology node may be broken down into the following sub-categories.

General Science, Space and Technology

National Aeronautics and Space Administration
National Science Foundation
Department of Energy

Accordingly, the General Science, Space and Technology spending category is a first order branch decision node. NASA, NSF and DOE are second-order decision nodes, and because each of these nodes contains sub-categories of spending, they may also be branch decision nodes. These second-order decision nodes have the following addresses.

| General Science, Space and Technology Spending Category | Address |
|---|---|
| National Aeronautics and Space Administration | Node_{c,a} |
| National Science Foundation | Node_{c,b} |
| Department of Energy | Node_{c,c} |

Furthermore, each of these spending sub-categories, or second-order decision nodes is broken down into spending sub-sub categories, or third-order decision nodes with the following addresses:

| | Address |
|---|---|
| NASA Sub-category | |
| space science | Node_{c,a,a} |
| earth science | Node_{c,a,b} |
| aerospace technology | Node_{c,a,c} |
| human exploration and development of space | Node_{c,a,d} |
| biological and physical research | Node_{c,a,c} |
| NSF Sub-category | |
| people | Node_{c,b,a} |
| ideas | Node_{c,b,b} |
| tools | Node_{c,b,c} |
| DOE Sub-category | |
| basic energy science | Node_{c,c,a} |
| advanced scientific computing research | Node_{c,c,b} |
| biological and environmental research | Node_{c,c,c} |
| high energy and nuclear physics | Node_{c,c,d} |
| fusion energy sciences | Node_{c,c,c} |

If these third-order decision nodes were not further divided into more detailed spending categories, these would be third-order leaf nodes. For the sake of example, we will consider them leaf nodes, and end our example here. It is, however, possible, for only one of the third-order nodes to be a leaf node, while the others are branch nodes. Thus the system can accommodate a any amount of detail for any spending category.

The system could be used to prevent channeling to special interests or spending in impermissible areas. Minimum contributions could be required in some areas such as debt service. A built in deadline that becomes non-negotiable at some point could prevent late budgets. This would solve a problem that plagues municipal, county, state, provincial and federal governments. The system could be used to track changes in spending over time and would give constituents a clear picture of their legislator's priorities.

Thus it will be appreciated that described herein is a highly adaptable decision-making system. The system has been designed to allow any sub-process that can be represented as a node to operate within its confines and interact meaningfully (cross-optimization) with any other sub-processes. By associating nodes, a decision process may account for information that other decision processes, or all decision processes, in the system have accounted for without burdening a participant with all data incorporated into those other decision processes. Various embodiments of the system could have any degree of geographic scope, and may be expanded to create a worldwide decision-making system, in which any group would be able to define itself as a set of decision-makers, but have access to data being used by all other sets of decision-makers. Thus, in one aspect there is described herein an interactive network that combines sharing of information with dynamic, shared decision-making processes beyond what is possible with current search engine and online collaborative technology.

Having described the invention in connection with the preferred embodiments shown and described in detail, various modifications and improvements thereon will become readily apparent to those skilled in the art. Accordingly, the spirit and scope of the present invention is to be limited only by the following claims.

1. A method comprising:
providing a node, the node including a description of a decision, a specification of a plurality of users with the authority to participate in the decision, a specification of a relationship of the node with one or more other nodes in a decision tree, and one or more criteria for affecting the node; and
collecting votes related to the node from one or more of the plurality of users to affect the node according to the one or more criteria.

2. The method of claim 1 wherein the description of the decision includes a numerical value.

3. The method of claim 2 wherein the numerical value includes at least one of an allocation of resources, an allocation of value to the decision, an assignment of numerical value to a question, or a specification of a probability.

4. The method of claim 2 wherein the numerical value varies according to user votes.

5. The method of claim 1 wherein the description of the decision includes a text value.

6. The method of claim 5 wherein the text value includes at least one of a choice among two or more alternatives, a choice between language alternatives, a yes/no choice for a proposal, or a polling choice.

7. The method of claim 1 further comprising displaying the decision tree.

8. The method of claim 1 further comprising displaying information relating to the node.

9. The method of claim 1 further comprising gathering a plurality of comments on the node for retrieval and display by one of the plurality of users.

10. The method of claim 1 further comprising establishing voting rights for each one of the plurality of users.

11. The method of claim 10 wherein the voting rights include a relative value of a vote for the user.

12. The method of claim 10 wherein the voting rights include a restriction of voting rights to one or more of a plurality of decision nodes.

13. The method of claim 1 further comprising delegating one or more voting rights for one of the plurality of users to a representative.

14. The method of claim 13 wherein the representative is another one of the plurality of users.

15. The method of claim 1 further comprising establishing an architect with an authority to at least one of add the node to the decision tree or remove the node from the decision tree.

16. The method of claim 1 further comprising establishing an architect with an authority to at least one of create, modify, archive, or delete the node.

17. The method of claim 15 wherein the architect delegates the authority to another user.

18. The method of claim 1 further comprising establishing an architect with an authority to set procedures for modifying the decision tree.

19. The method of claim 18 wherein the architect delegates the authority to another user.

20. The method of claim 1 further comprising adding a new node to the decision tree, and converting the new node into a decision node if at least one of voting criteria are satisfied, other criteria are satisfied, or an evaluation concludes that the new node should be converted.

21. The method of claim 1 further comprising archiving the node.

22. The method of claim 1 further comprising associating a status with the node.

23. The method of claim 22 wherein the status includes at least one of a proposal node, a sponsored node, a decision node, a resolved node, or an archived node.

24. The method of claim 21 further comprising upgrading the status.

25. The method of claim 21 further comprising downgrading the status.

26. The method of claim 1 further comprising establishing a floating period during which users have an authority to change a vote related to the node.

27. The method of claim 1 wherein collecting votes has a variable end time.

28. The method of claim 1 wherein the relationship of the node with one or more other nodes includes a link to an ancestor node higher in the decision tree.

29. The method of claim 1 wherein the relationship of the node with one or more other nodes includes a link to one or more descendant nodes lower in the decision tree.

30. The method of claim 1 wherein the relationship of the node with one or more other nodes includes a link to a competitive node.

31. The method of claim 1 further comprising inserting a portion of the decision tree into a node of another decision tree.

32. The method of claim 1 further comprising inserting the decision tree into a node of another decision tree.

33. The method of claim 1 wherein the node includes an address that uniquely identifies a location of the node in the decision tree.

34. A computer program product embodied in a computer readable medium comprising:
computer executable code for providing a node, the node including a description of a decision, a specification of a plurality of users with the authority to participate in the decision, a specification of a relationship of the node with one or more other nodes in a decision tree, and one or more criteria for affecting the node; and
computer executable code for collecting votes related to the node from one or more of the plurality of users to affect the node according to the one or more criteria.

35. A system comprising:
providing means for providing a node, the node including a description of a decision, a specification of a plurality of users with the authority to participate in the decision, a specification of a relationship of the node with one or more other nodes in a decision tree, and one or more criteria for affecting the node; and
voting means for collecting votes related to the node from one or more of the plurality of users to affect the node according to the one or more criteria.

36. A system comprising:
a host including a database storing at least one node, the node including a description of a decision, a specification of a plurality of users with the authority to participate in the decision, a specification of a relationship of the node with one or more other nodes in a decision tree, and one or more criteria affecting the node; and
a network interconnecting the host with a plurality of clients, each one of the clients configured to receive one or more votes related to the node from one of the plurality of users.

37. A system comprising:
a client device, the client device connected to a collaborative decision making system; and
a user interface displayed by the client device, the user interface presenting a description of a decision and a relationship of the decision with one or more nodes of a decision tree, the interface including one or more controls for interacting with the system including a control for voting on the decision.

38. The system of claim 37 further comprising a control for giving or receiving a proxy to vote on the decision.

39. The system of claim 37 wherein the user interface further displays a resolution date for the decision.

40. The system of claim 37 wherein the user interface further displays one or more links to sources of information, the sources of information including at least one of statistical data, newsgroups, or news sources.

41. A method for resolving a decision comprising:
presenting the decision to a plurality of users for a vote;
establishing a floating period for resolution of the decision, the floating period ending at a time determined by one or more objective events;
gathering votes;
upon the occurrence of one of the one or more objective events, fixing the time for ending the vote; and
gathering votes until the time for ending the vote.

42. The method of claim 41 further comprising changing the time for ending the vote upon the occurrence of one or more other objective events.

43. The method of claim 41 further comprising permitting one or more of the plurality of users to change a vote during the floating period.

44. The method of claim 41 further comprising providing information relating to the votes for display during the floating period.

45. The method of claim 44 wherein the information includes projected outcomes.
